(19) United States
(12) Patent Application Publication
(10) Pub. No.: US 2012/0169499 A1
(43) Pub. Date: Jul. 5, 2012

(54) METHOD AND SYSTEM FOR MONITORING PHYSICAL SECURITY VIA DETECTING POTENTIAL INTRUSION

(75) Inventor: Richard L. Dubois, JR., Chester, NH (US)

(73) Assignee: SCHNEIDER ELECTRIC BUILDINGS AB, MALMO (SE)

(21) Appl. No.: 12/982,937

(22) Filed: Dec. 31, 2010

(51) Int. Cl. G08B 13/26; G08B 13/00

(52) U.S. Cl. 340/562; 340/541

(57) ABSTRACT

A method and system for detecting potential intrusion includes a plurality of objects that can be potentially touched, such as a door handle. A sensor is associated with the object that can be potentially touched for determining if the object has been touched. The system has a control system for receiving information from the plurality of sensors and a database for collecting information regarding potential intrusions. The system has an intrusion detection system for analyzing the relative time and location of the object to be touched for analyzing the data gathered to determine patterns and variations from the patterns. An operator is notified of potential intrusions.

### FIELD OF THE INVENTION

This invention relates to physical security and access control and, in particular, the monitoring and analysis of activity to detect potential intrusion.

### BACKGROUND OF THE INVENTION

It is common to detect intrusion as it occurs or after it occurs through door or window alarms. It is also possible to determine potential intrusion in situations where the area to be protected has a region around the protected area; the detection is determined by intrusion into this outer region.

It is also know to have door-based detection that individuals can use in locations such as hotels with alarms that will sound an audible alert if someone on the other side of the door is attempting to turn the handle. These devices are standalone alarms. Typically, they are battery powered and are hung by a chain over the door knob on the inside of the door.

### SUMMARY OF THE INVENTION

It is recognized that certain characteristics can be a precursory to an intrusion. One such precursory is the touch or trying of a series of similar objects such as door handles to see if one is not properly secured.

The invention relates to a method and system for detecting potential intrusion. The system includes a plurality of objects that can be potentially touched, such as a door handle. A sensor is associated with the object that can be potentially touched for determining if the object has been touched. The system has a control system for receiving information from the plurality of sensors and a database for collecting information regarding potential intrusion. The system has an intrusion detection system for analyzing the relative time and location of the item touched for analyzing the data gathered to determine patterns and variations from the patterns. An operator is notified of a potential intrusion.

In an embodiment of the invention, a security system for detecting potential intrusion includes a plurality of sensors. Each of the sensors is capable of detecting a party in proximity to the sensor. The system has a control system for receiving information from the plurality of sensors. A database collects information regarding potential intrusions. An intrusion detection system of the security system analyzes the relative time and location of sensors for analyzing the data gathered to determine patterns and variations from the patterns. An operator is notified of potential intrusions by a notification system.

In an embodiment, the sensor is a capacitive sensor. In an embodiment, the sensor is wirelessly connected to the control system.

In an embodiment, the sensor is associated with a door handle. In an embodiment, the sensor is associated with a metal component.

In an embodiment, the criteria can be adjusted as to the relationship between time and location that is considered a potential intrusion and the type of notification for such potential intrusion.

In one embodiment, a security system for detecting potential intrusion includes a plurality of objects that can be potentially touched. A sensor is associated with the object that can be potentially touched for determining if the object has been touched. The system has a control system for receiving information from the plurality of sensors. A database collects information regarding potential intrusion. An intrusion detection system of the security system analyzes the relative time and location of the object to be touched for analyzing the data gathered to determine patterns and variations from the patterns. An operator is notified of potential intrusion by a notification system.

In a method of the invention for detecting potential intrusion, providing a plurality of objects that can be potentially touched, if an object has been touched, as determined by use of a sensor associated with the object that can be potentially touched, a control system receives information from the plurality of sensors. Information is collected regarding potential intrusions in a database. An intrusion detection system analyzes the relative time and location of the object to be touched for analyzing the data gathered to determine patterns and variations from the patterns. A notification system notifies an operator of potential intrusions.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a pictorial display of a building;

FIG. 2 shows a pictorial display of a portion of a door;

FIG. 3 is a schematic of a system for analyzing a building's physical system according to the invention; and

FIG. 4 is a schematic of a method for detecting intrusion or potential intrusion.

### DETAILED DESCRIPTION OF PREFERRED EMBODIMENTS

The system and method of the present invention monitors potential intrusion and includes a plurality of objects that can be potentially touched, such as a door handle. A sensor is associated with the object that can be potentially touched for determining if the object has been touched. The system has a control system for receiving information from the plurality of sensors and a database for collecting information regarding potential intrusions. The system has an intrusion detection system for analyzing the relative time and location of the object to be touched for analyzing the data gathered to determine patterns and variations from the patterns. An operator is notified of potential intrusions.

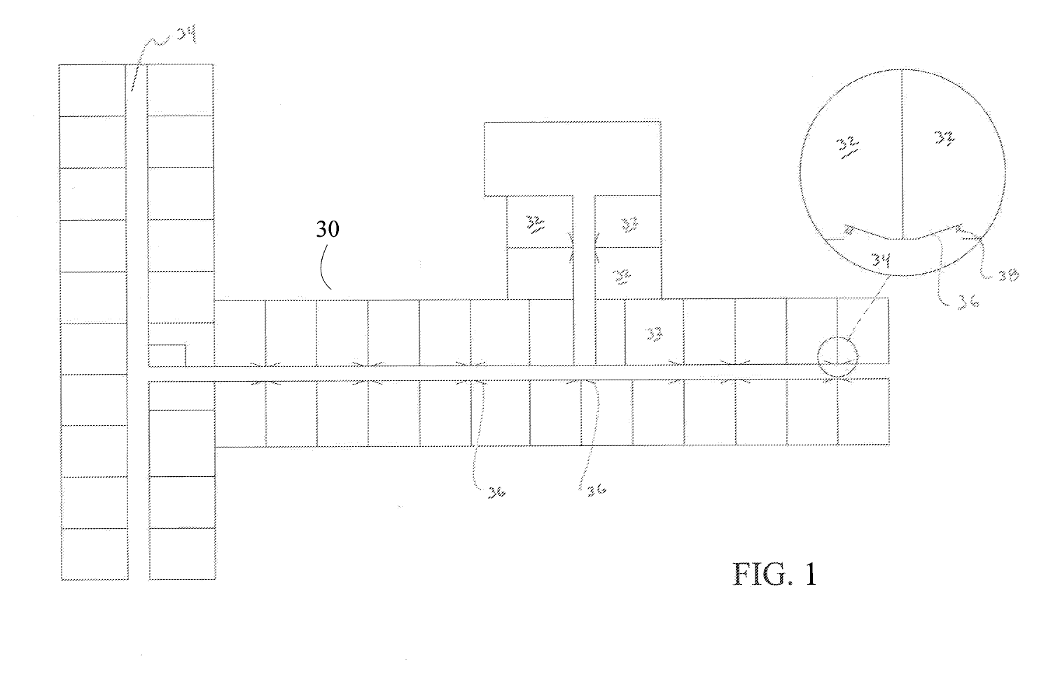

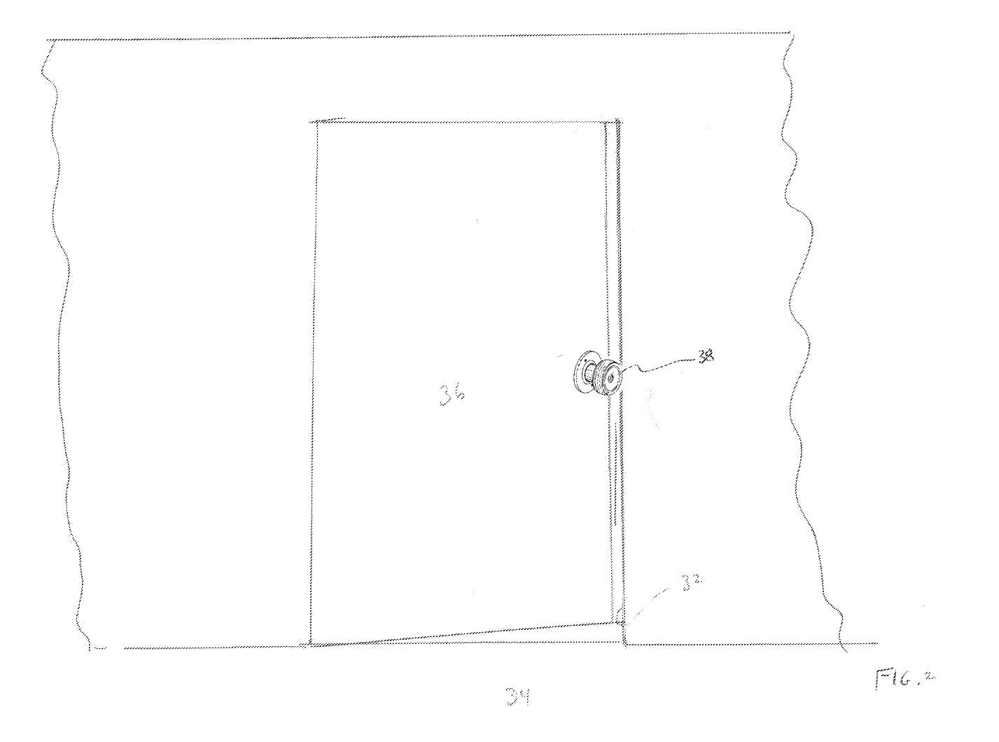

Referring to FIG. 1, a pictorial display of a building 30 that uses a system 20 for analyzing a building's physical system is shown. The building 30, such as a hotel or dorm, has a plurality of rooms 32 off of a plurality of halls 34. Each of the rooms 32 has a door 36 which has a handle 38 as seen in FIG. 2.

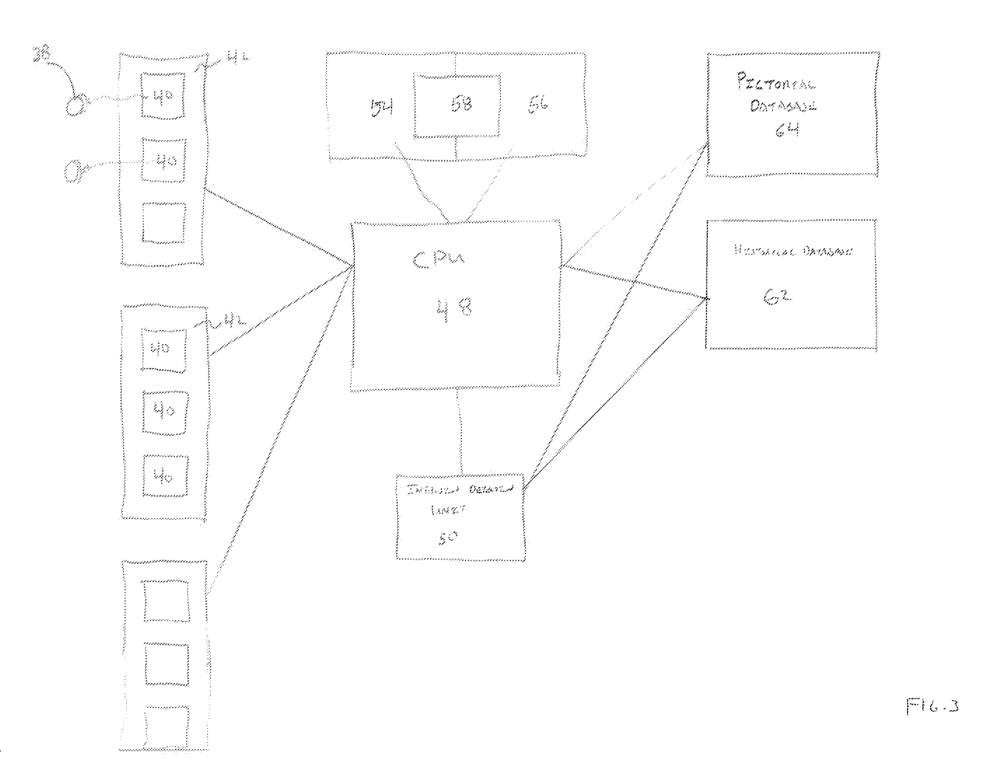

Referring to FIG. 2, a pictorial display of a portion of the door 36 is shown. The handle 38, which has portions that are metal, is connected a capacitive sensor 40, such as seen in FIG. 3. The capacitive sensor 40 can detect when items that have conductive or having dielectric properties such as person's hand, have touched the door handle.

Referring to FIG. 3, a schematic of the system 20 for analyzing the building's 40 physical system is shown. The system 20 has a plurality of the capacitive sensors 40. In one embodiment, a group of capacitive sensors 40 are carried by an input/output (I/O) module 42.

The system 20 has a controller or central processing unit 48 for controlling the system 20. The CPU 48 works in conjunction with an intrusion detection unit 50. The CPU 48 of the system 20 receives a signal from the capacitive sensor 40 when a door handle 38 is handled or touched. While touching the door handle 38 may be proper, such as someone accessing their room, the touching of the door handle 38 may be improper as explained below.

Still referring to FIG. 3, the system 20 includes an interface device 54 for receiving operator input and a graphical display screen 56 for displaying information to allow an operator to control the system 20. In one embodiment, the interface device 54 is a keyboard and a pointer controller such as a mouse or tracker ball. In another embodiment, the interface device 54 and the graphical display screen 56 are incorporated into one device such as a touch screen 58.

The system 20 has a historical database 62 that is written to when a signal is received from the capacitive sensor 40. In addition, the system 20 has a building database 64. The building database 64 contains information regarding the building and can include relative locations of door handles 38 associated with each capacitive sensor 40.

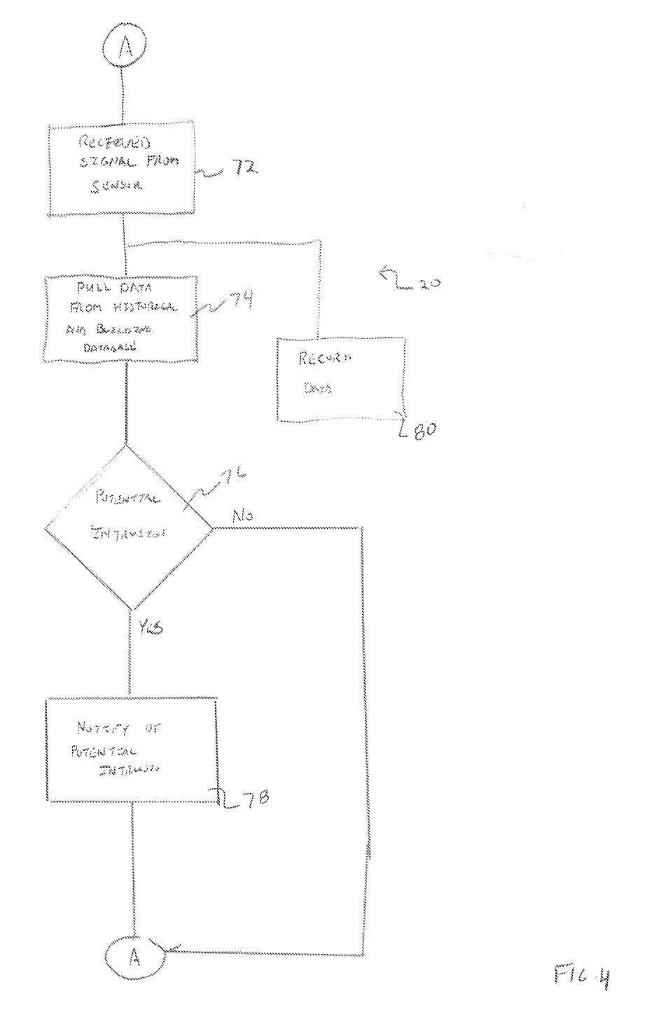

Referring to FIG. 4, a schematic of a method for detecting intrusion or potential intrusion is shown. The system 20 receives a signal from the sensor 40 that the door handle 38 has been touched, as represented by block 72. The system 20 pulls information from the historical database 62 and the building database 64, as represented by block 74. The system 20 in the intrusion detection unit 50 determines if a potential intrusion has occurred, as represented by decision diamond 76. The intrusion detection unit 50 looks at several factors including number of signals received from various sensors 40 in the system 20 and the timing between signals and location of the devices, i.e. the door handles 38 associated with the sensor 40.

Still referring to FIG. 4, if the system determines that there is a potential intrusion as represented by the “yes” path, the system 20 notifies the operator of the potential intrusion as represented by block 78.

Still referring to FIG. 4, if the system 20 determines that there is no potential intrusion as represented by the “no” path, the system 20 continues to monitor the sensors.

While the system 20 is determining if the last touch, such as of a door handle 38, is cause to the system 20 to notify the operator, the system 20 is also writing information related to this touch to the historical database 62 so future potential touches can pull this information from the historical database 62. Block 80 in FIG. 4 represents the writing of the information to the historical database 62.

Examining in more detail the intrusion detection unit 50, after the intrusion detection unit 50 has received the signal from the capacitive sensor 40 that the handle 38 has been touched, the system 20 pulls the recent history of other signals that are stored in the historical database 62, as referenced by block 74 in FIG. 3. The intrusion detection system 20 in the intrusion detection unit 50 examines the location with the current signal in relation to that of previous signals both in time and location. If the system determines a possible potential infringement, the system will notify the operator as represented by block 78 in FIG. 3

Referring to FIG. 1, if two adjacent doors on a hallway are touched, depending on the settings, the system may or may not notify the operator. The system may be set to indicate that this is a common occurrence, such as a guest, not realizing that they are off by one door in attempting to get back in their room.

However, if the system detects that several doors, for example more than five doors, in proximity to each other have been touched in a short time period, the system will notify the operator. The method of notification could vary dependent on location or time. For example, on the weekend a hotel may automatically place a video image on a primary screen so that security can see the hall. No alarms or notification will be sent to the hallway. The operator may determine that based on the clientele, this is the proper level of security, in that it could be a group of kids running down the hall touching doors. In contrast, an office building at night might have audible alarm if as little as two adjacent doors handles 38 are touched.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

While a capacitive sensor is described above, it is recognized that other types of detectors /sensors such as video analytics, pressure sensors, and light detecting diodes can be used with the system.

While the system as shown is hardwired between components, it is recognized that wireless connections can be used. For example, a unit on the door could have all the components wirelessly transmit to a receiver associated with input/output (I/O) module 42.

While the system has been described with doors to rooms, it is recognized that the system could be used with other devices such as a cabinet or other metal enclosure. It can also be used with a conductive tape to provide detection on non-metallic surfaces.

While the system has been described as a stand-alone system, the system could be connected to another system such as an access control system which allows access based on a database which lists access devices such as a card reader.

What is claimed is:

1. A security system for detecting potential intrusion, the system comprising:
a plurality of sensors, each of the sensors capable of detecting a party in proximity to the sensor;
a control system for receiving information from the plurality of sensors;
a database for collecting information regarding potential intrusions;
an intrusion detection system for analyzing the relative time and location of the sensors for analyzing the data gathered to determine patterns and variations from the patterns; and
a notification system for notifying an operator of potential intrusions.

2. A security system of claim 1 wherein the sensor is a capacitive sensor.

3. A security system of claim 1 wherein the sensor is wirelessly connected to the control system.

4. A security system of claim 1 wherein the items being monitored for flow are equipment.

5. A security system of claim 1 wherein criteria can be adjusted as to when an event is considered an anomaly and the type of notification for such an anomaly.

6. A security system for detecting potential intrusion, the system comprising:
a plurality of objects that can be potentially touched;
a sensor associated with the object that can be potentially touched for determining if the object has been touched;
a control system for receiving information from the plurality of sensors;
a database for collecting information regarding potential intrusion;
an intrusion detection system for analyzing the relative time and location of the object to be touched for analyzing the data gathered to determine patterns and variations from the patterns; and
a notification system for notifying an operator of potential intrusion.

7. A method for detecting potential intrusion comprising:
providing a plurality of objects that can be potentially touched;
determining if the object has been touched by use of a sensor associated with the object that can be potentially touched;
a control system for receiving information from the plurality of sensors;
collecting information regarding potential intrusions in a database;
an intrusion detection system for analyzing the relative time and location of the object to be touched for analyzing the data gathered to determine patterns and variations from the patterns; and
a notification system for notifying an operator of potential intrusions.

8. A method of claim 7 wherein the sensor is a capacitive sensor.

9. A method of claim 7 wherein the sensor is wirelessly connected to the control system.
